(19) United States
(12) Patent Application Publication
(10) Pub. No.: US 2026/0329866 A1
(43) Pub. Date: Oct. 22, 2026

(54) INFORMATION PROCESSING APPARATUS, INFORMATION PROCESSING METHOD, AND NON-TRANSITORY COMPUTER READABLE STORAGE MEDIUM

(71) Applicant: LY Corporation, Tokyo (JP)

(72) Inventors: Takahiro ISHIKAWA, Tokyo (JP); Kazuhiro HAYASHI, Tokyo (JP)

(21) Appl. No.: 19/558,060

(22) Filed: Mar. 5, 2026

(30) Foreign Application Priority Data
Mar. 19, 2025 (JP) 2025-045428

(51) Int. Cl. G06F 16/2455; G06F 16/248

(52) U.S. Cl. CPC G06F 16/24553; G06F 16/248

(57) ABSTRACT

An information processing apparatus according to the present application includes an acquisition unit, a generation unit, a search unit, and an evaluation unit. The acquisition unit acquires investigation target content serving as content to become an investigation target. The generation unit extracts a plurality of investigation targets from the investigation target content acquired by the acquisition unit, and generates a plurality of search queries for respectively searching for pieces of information corresponding to corresponding investigation targets among the plurality of investigation targets. The search unit performs a search using the search queries generated by the generation unit for each of the investigation targets. The evaluation unit evaluates, based on a search result for each of the investigation targets by the search unit, correctness of content of the investigation target content for each of the investigation targets.

### CROSS-REFERENCE TO RELATED APPLICATIONS

The present application claims priority to and incorporates by reference the entire contents of Japanese Patent Application No. 2025-045428 filed in Japan on Mar. 19, 2025.

### BACKGROUND OF THE INVENTION

### 1. Field of the Invention

The present invention relates to an information processing apparatus, an information processing method, and a non-transitory computer readable storage medium.

### 2. Description of the Related Art

In recent years, with the rapid spread of the Internet, content such as news has been distributed. For example, in such content, a technology for providing summarized content summarizing information such as news and posts has been proposed (refer to, for example, JP 2019-191702 A).

However, in the above-described related art, in a case in which content such as news and posts to be summarized includes incorrect information, the summarized content may also include incorrect information. This concern is not limited to summarized content, and the same applies to content such as news and posts that are not summarized.

### SUMMARY OF THE INVENTION

An information processing apparatus according to the present application includes an acquisition unit, a generation unit, a search unit, and an evaluation unit. The acquisition unit acquires investigation target content serving as content to become an investigation target. The generation unit extracts a plurality of investigation targets from the investigation target content acquired by the acquisition unit, and generates a plurality of search queries for respectively searching for pieces of information corresponding to corresponding investigation targets among the plurality of investigation targets. The search unit performs a search using the search queries generated by the generation unit for each of the investigation targets. The evaluation unit evaluates, based on a search result for each of the investigation targets by the search unit, correctness of content of the investigation target content for each of the investigation targets.

It should be noted that some or all of the above-described means for solving the problem may be implemented using various artificial intelligence-related technologies and techniques, including, but not limited to, the use of various generative AI models implemented using machine learning, deep learning, large language models, and the like.

### BRIEF DESCRIPTION OF THE DRAWINGS

FIG. 1 is a diagram for description of information processing according to an embodiment;

FIG. 2 is a diagram illustrating an example of a configuration of an information processing system according to the embodiment;

FIG. 3 is a diagram illustrating an example of a configuration of an information processing apparatus according to the embodiment;

FIG. 4 is a diagram illustrating an example of investigation target content acquired by an acquisition unit of the information processing apparatus according to the embodiment;

FIG. 5 is a diagram illustrating an example of an investigation result provided by a provision unit of the information processing apparatus according to the embodiment;

FIG. 6 is a flowchart illustrating an example of information processing by a processing unit of the information processing apparatus according to the embodiment; and

FIG. 7 is a hardware configuration diagram illustrating an example of a computer that implements the functions of the information processing apparatus according to the embodiment.

### DETAILED DESCRIPTION OF THE PREFERRED EMBODIMENTS

Hereinafter, modes (hereinafter referred to as “embodiments”) for implementing an information processing apparatus, an information processing method, and a non-transitory computer readable storage medium according to the present application will be described in detail with reference to the drawings. Note that the information processing apparatus, the information processing method, and the non-transitory computer readable storage medium according to the present application are not limited by these embodiments. In addition, the respective embodiments can be appropriately combined within a range in which the processing contents do not contradict each other. In the following embodiments, the same parts will be denoted by the same reference numerals, and redundant descriptions thereof will be omitted.

### 1. Example of Information Processing

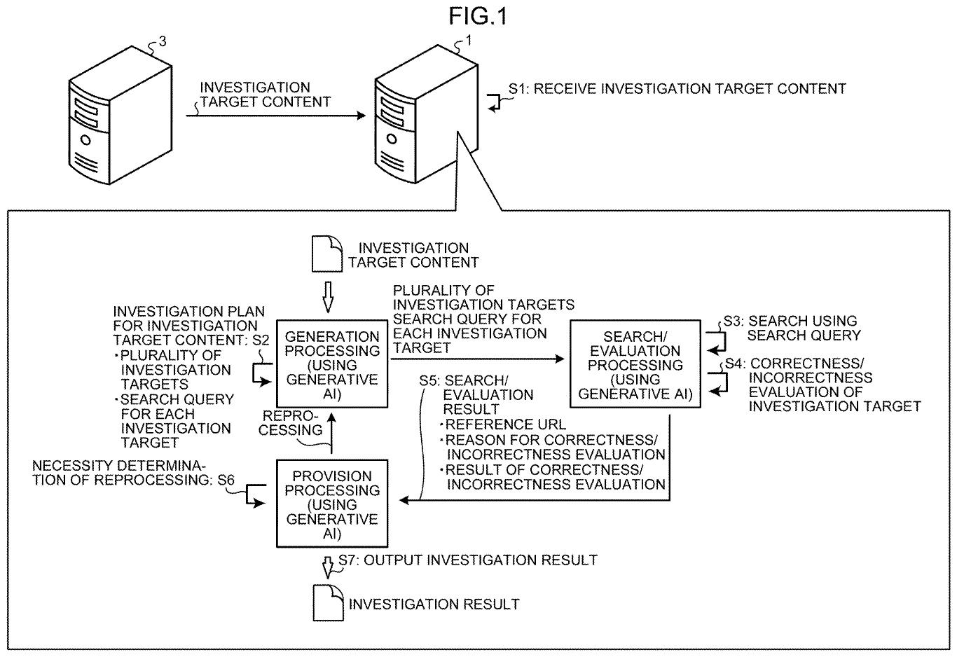

First, an example of information processing according to an embodiment will be described with reference to FIG. 1. FIG. 1 is a diagram for description of information processing according to an embodiment.

As illustrated in FIG. 1, an information processing apparatus 1 receives investigation target content transmitted from an information providing device 3, a terminal device (not illustrated), or the like (Step S1). The investigation target content is content to become the investigation target, and examples thereof include summarized content which is content obtained by summarizing a plurality of pieces of post information, news content which is a news article, and the like, but the investigation target content is not limited to such examples. For example, the investigation target content may be the post information itself.

Examples of the post information include, but are not limited to, user post information related to a news article, user post information on a Social Networking Service (SNS), and the like. Examples of user post information related to the news article include a comment of a user on the news article and a comment of another user on the comment of the user on the news article. Examples of the user post information on an SNS include post information posted by a user, post information posted in response to post information posted by another user, and the like. Hereinafter, content obtained by summarizing a plurality of pieces of post information may be referred to as summarized content.

The summarized content is, for example, content obtained by summarizing a plurality of pieces of post information with generative AI, but the summarized content is not limited to such an example. For example, the summarized content may be content obtained by summarizing a news article, or may be content obtained by summarizing a blog. The generative AI is, for example, a Large Language Model (LLM) or the like, and is a text-generating AI that receives an input of text and provides an output of text, however, the generative AI is not limited to such an example. For example, the generative AI may be a multi-modal generative AI capable of receiving an input of text and an image and providing an output of text and an image.

Subsequently, the information processing apparatus 1 formulates an investigation plan for the investigation target content acquired in Step S1 (Step S2). The investigation plan includes a plurality of investigation targets and a search query for each of the investigation targets. In Step S2, the information processing apparatus 1 executes generation processing of extracting a plurality of investigation targets from the investigation target content acquired in Step S1, and generating a plurality of search queries for respectively searching for pieces of information corresponding to the corresponding investigation targets among the plurality of investigation targets.

Each of the plurality of investigation targets is a target of investigation as to whether the investigation target is correct. For example, each of the plurality of investigation targets is information obtained by summarizing information included in the investigation target content, but may be information itself included in the investigation target content. Further, each of the plurality of investigation targets is represented by a character string, but may include an image in addition to the character string. In addition, some of the plurality of investigation targets may include only an image without including a character string.

In Step S2, the information processing apparatus 1 can perform the above-described generation processing using the generative AI. For example, the information processing apparatus 1 generates, as input information, information including the investigation target content and instruction information including an instruction to extract a plurality of investigation targets from the investigation target content and generate a plurality of search queries for respectively searching for pieces of information corresponding to the corresponding investigation targets among these plurality of investigation targets.

The instruction information includes, for example, information of a character string “Please extract a plurality of investigation targets from the given investigation target content and generate a plurality of search queries for respectively searching for information corresponding to the corresponding investigation targets among these plurality of investigation targets. Please output the investigation targets and the search queries by associating the investigation targets and the search queries with each other for each investigation target.”, but is not limited to such an example.

The information processing apparatus 1 uses the generative AI via an Application Programming Interface (API) provided by an external information processing apparatus, but is not limited to such an example. For example, the information processing apparatus 1 may have a configuration in which the generative AI is provided inside and the internal generative AI is used.

Subsequently, the information processing apparatus 1 executes, for each investigation target, search processing of performing a search using the search query generated in step S2 (Step S3). The search query generated in Step S2 includes, for example, one or more search keywords, and the information processing apparatus 1 performs a search for one or more pieces of web content or the like using the search query generated in Step S2.

Subsequently, the information processing apparatus 1 executes, based on the search result obtained in Step S3, evaluation processing of evaluating whether the content of the investigation target corresponding to the search query used in Step S3 is correct (Step S4). For example, the information processing apparatus 1 uses the generative AI to evaluate whether the content of the investigation target corresponding to the search query used in Step S3 is correct for each investigation target.

For example, the information processing apparatus 1 generates, for each investigation target, input information (a prompt) including the investigation target corresponding to the search query used in Step S3, the search result obtained in Step S3, and instruction information including an instruction sentence to instruct an evaluation of the correctness of the content of the investigation target. The information processing apparatus 1 inputs the generated input information (the prompt) into the generative AI, and causes the generative AI to output, for each investigation target, an evaluation result of the correctness of the content of the investigation target.

The instruction information in this case includes, for example, information of the character string “Please perform an evaluation of whether the content of the given investigation target is correct, based on the given search result. Please output the evaluation result together with the reason for the evaluation. In addition, if it is not possible to evaluate whether the content of the given investigation target is correct, please output to that effect.”, but is not limited to such an example.

Note that the information processing apparatus 1 can also cause the generative AI to evaluate, at once, the correctness of the contents of the plurality of investigation targets. For example, the information processing apparatus 1 generates input information (a prompt) including a set of an investigation target and a search result for each investigation target, and including instruction information instructing the evaluation of correctness of the content of each investigation target. The information processing apparatus 1 inputs the generated input information (prompt) into the generative AI, and causes the generative AI to output, at once, an evaluation result of the correctness of the content of each investigation target.

The information processing apparatus 1 repeats the processing of Steps S3 and S4 up to a maximum of m times (m is an integer of 2 or more) until an evaluation of whether the content of the investigation target is correct is obtained. The information processing apparatus 1 ends the processing of Steps S3 and S4 corresponding to the investigation target in a case in which the evaluation of whether the content of the investigation target is correct is obtained, or in a case in which the processing of steps S3 and S4 has been repeated m times.

Subsequently, the information processing apparatus 1 generates a search/evaluation result which is a result of the processing in Steps S3 and S4 (Step S5). The search/evaluation result includes a reference Uniform Resource Locator (URL), a reason for correctness/incorrectness evaluation, a result of correctness/incorrectness evaluation, and the like.

The reference URL is, for example, a URL of web content that is web content searched in Step S3 and serves as a basis for the correctness/incorrectness evaluation. The reason for the correctness/incorrectness evaluation is a reason for having evaluated whether the content of the investigation target is correct. The result of the correctness/incorrectness evaluation is an evaluation result of whether the content of the investigation target is correct, and includes information indicating that the truth or falsity is unknown in a case in which the evaluation of whether the content of the investigation target is correct could not be performed in Step S4. The information indicating that the truth or falsity is unknown is information indicating that it is unknown whether the content of the investigation target is correct.

Note that the information processing apparatus 1 can also further evaluate the overall correctness of the content of the investigation target content in addition to the correctness/incorrectness evaluation for each investigation target in Step S5. The evaluation of the overall correctness of the content of the investigation target content is a comprehensive evaluation based on the correctness/incorrectness evaluation for each investigation target.

For example, the information processing apparatus 1 can also input, into the generative AI, input information including a correctness/incorrectness evaluation for each investigation target and instruction information including an instruction sentence to instruct an evaluation of the overall correctness of the content of the investigation target content from the correctness/incorrectness evaluation for each investigation target, and cause the generative AI to output information indicating whether the content of the investigation target content is overall correct. In this case, the search/evaluation result includes information indicating whether the content of the investigation target content is overall correct.

Subsequently, the information processing apparatus 1 performs, based on the search/evaluation result generated in Step S5, a necessity determination of reprocessing (Step S6). For example, the information processing apparatus 1 determines whether there is an investigation target whose result of the correctness/incorrectness evaluation includes information indicating that the truth or falsity is unknown. Then, the information processing apparatus 1 determines that reprocessing is necessary for an investigation target in a case in which there is an investigation target whose result of the correctness/incorrectness evaluation includes information indicating that the truth or falsity is unknown, and determines that reprocessing is not necessary for the investigation target in a case in which there is no investigation target.

In a case in which there is an investigation target for which reprocessing is necessary, the information processing apparatus 1 generates another search query for the investigation target, and performs the processing of Steps S3, S4, and S5 using the search query until there is no investigation target whose result of the correctness/incorrectness evaluation includes information indicating that the truth or falsity is unknown. In this way, the information processing apparatus 1 generates a new search query corresponding to an investigation target evaluated as having unknown correctness for the content of the investigation target content, and performs, based on the generated new search query, a re-evaluation of whether the content of the investigation target is correct.

In a case in which the result of the correctness/incorrectness evaluation for all the investigation targets indicates whether the contents of the investigation targets are correct, the information processing apparatus 1 outputs the investigation result (Step S7). The investigation results include, for example, a reference URL, a reason for the correctness/incorrectness evaluation, a result of the correctness/incorrectness evaluation, and the like, and these pieces of information are shown, for example, in a JSON format.

In this way, the information processing apparatus 1 according to the embodiment extracts a plurality of investigation targets from investigation target content, which is content to become the investigation target, and generates a plurality of search queries for respectively searching for pieces of information corresponding to corresponding investigation targets among these plurality of investigation targets. Then, the information processing apparatus 1 performs a search using the search query for each investigation target, and evaluates, based on a search result for each investigation target, the correctness of the content of the investigation target content for each investigation target. Accordingly, the information processing apparatus 1 can evaluate the correctness of the content of the investigation target content.

Hereinafter, a configuration and the like of an information processing system including the information processing apparatus 1 and the information providing device 3 that perform such processing will be described in detail.

### 2. Configuration of Information Processing System

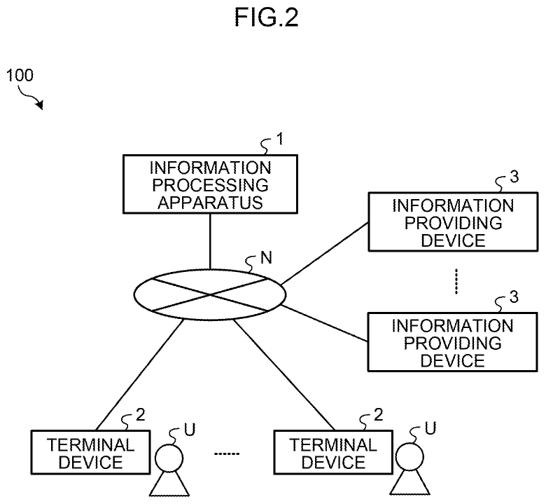

FIG. 2 is a diagram illustrating an example of a configuration of an information processing system according to the embodiment. As illustrated in FIG. 2, an information processing system 100 according to the embodiment includes the information processing apparatus 1, a plurality of terminal devices 2, and a plurality of information providing devices 3.

The plurality of terminal devices 2 are used by different users U. The terminal device 2 is, for example, a notebook Personal Computer (PC), a desktop PC, a smartphone, a tablet PC, or a wearable device. The wearable device is, for example, a smart glass, a smart watch, or the like, but is not limited to such examples.

The information processing apparatus 1, the terminal device 2, and the information providing device 3 are connected to each other via a network N so as to be able to communicate with each other in a wired or wireless manner. Note that the information processing system 100 illustrated in FIG. 2 may include a plurality of information processing apparatuses 1 and the like.

The network N includes, for example, a Wide Area Network (WAN) such as the Internet, a mobile communication network such as Long Term Evolution (LTE), 4th Generation (4G), or 5th Generation (5G: 5th Generation Mobile Communication System), and the like but is not limited to such an example.

The terminal device 2 is connected to the network N via short-range wireless communication such as a mobile communication network, Bluetooth (registered trademark), or a wireless Local Area Network (LAN), and can communicate with the information processing apparatus 1 or the like.

### 3. Configuration of Information Processing Apparatus 1

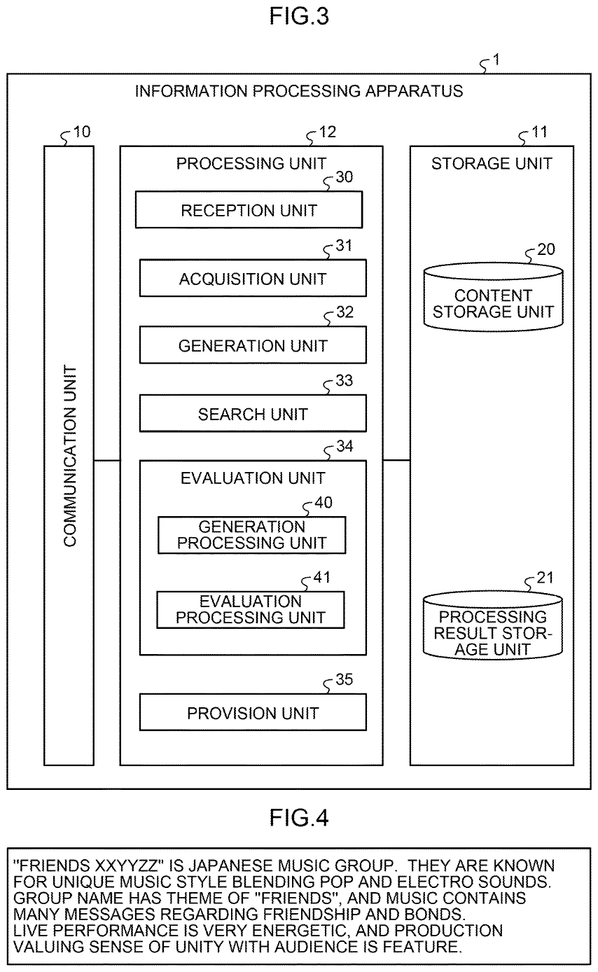

FIG. 3 is a diagram illustrating an example of a configuration of the information processing apparatus 1 according to the embodiment. As illustrated in FIG. 3, the information processing apparatus 1 includes a communication unit 10, a storage unit 11, and a processing unit 12.

### [3.1. Communication Unit 10]

The communication unit 10 is implemented by, for example, a communication module, a Network Interface Card (NIC), or the like. Then, the communication unit 10 is connected to the network N in a wired or wireless manner, and transmits and receives information to and from various other devices. For example, the communication unit 10 transmits and receives information to and from each of the terminal device 2 and the information providing device 3 via the network N.

### [3.2. Storage Unit 11]

The storage unit 11 is implemented by, for example, a semiconductor memory element such as a Random Access Memory (RAM) or a flash memory, or a storage device such as a hard disk or an optical disk. The storage unit 11 includes a content storage unit 20 and a processing result storage unit 21.

The content storage unit 20 stores one or more pieces of investigation target content. The investigation target content is content to become the investigation target, and is, for example, summarized content obtained by summarizing a plurality of pieces of post information, but is not limited to such an example. For example, the investigation target content may be the post information itself. The summarized content may be, for example, content obtained by summarizing a news article, or may be content obtained by summarizing a blog.

The post information is, for example, post information of a user U regarding a news article, post information of the user U on an SNS, and the like, but is not limited to such examples. Note that the investigation target content may be a news article, a piece of post information, a paper, a technical report, a presentation material, or the like.

The processing result storage unit 21 stores a search/evaluation result, an investigation result, and the like for each investigation target content. The search/evaluation result, the investigation result, and the like include, for example, a reference URL, a reason for correctness/incorrectness evaluation, a result of correctness/incorrectness evaluation, and the like, but are not limited to such examples.

### [3.3. Processing Unit 12]

The processing unit 12 is a controller and is implemented by, for example, a processor such as a Central Processing Unit (CPU) or a Micro Processing Unit (MPU) executing various programs (corresponding to an example of an information processing program) stored in a storage device inside the information processing apparatus 1 using a RAM or the like as a work area.

Furthermore, the processing unit 12 is a controller, and for example, a part or all of the processing unit 12 may be implemented by an integrated circuit such as an Application Specific Integrated Circuit (ASIC), a Field Programmable Gate Array (FPGA), or a General Purpose Graphic Processing Unit (GPGPU).

As illustrated in FIG. 3, the processing unit 12 includes a reception unit 30, an acquisition unit 31, a generation unit 32, a search unit 33, an evaluation unit 34, and a provision unit 35, and implements or executes functions and effects of information processing described below. Note that the internal configuration of the processing unit 12 is not limited to the configuration illustrated in FIG. 3, and may be another configuration as long as the configuration performs information processing to be described later.

### [3.3.1. Reception Unit 30]

The reception unit 30 receives various types of information and requests. For example, the reception unit 30 receives investigation target content transmitted from the information providing device 3, the terminal device 2, or the like. The reception unit 30 stores the received investigation target content in the content storage unit 20.

### [3.3.2. Acquisition Unit 31]

The acquisition unit 31 acquires various types of information from an external device (for example, the information providing device 3 or the terminal device 2) or the storage unit 11. For example, the acquisition unit 31 acquires investigation target content, which is content to become the investigation target, from the content storage unit 20 or the like.

### [3.3.3. Generation Unit 32]

The generation unit 32 generates various types of information. For example, the generation unit 32 extracts a plurality of investigation targets from the investigation target content acquired by the acquisition unit 31, and generates a plurality of search queries for respectively searching for pieces of information corresponding to the corresponding investigation targets among these plurality of investigation targets.

Each of the plurality of investigation targets is a target of investigation as to whether the investigation target is correct. For example, each of the plurality of investigation targets is information obtained by summarizing information included in the investigation target content, but may be information itself included in the investigation target content. Further, each of the plurality of investigation targets is represented by a character string, but may include an image in addition to the character string. In addition, some of the plurality of investigation targets may include only an image without including a character string.

The generation unit 32 can perform extraction of the plurality of investigation targets and generation of search queries for each investigation target by using the generative AI. For example, the generation unit 32 generates, as input information, information including the investigation target content and instruction information including an instruction sentence to extract a plurality of investigation targets from the investigation target content and generate a plurality of search queries for respectively searching for pieces of information corresponding to the corresponding investigation targets among these plurality of investigation targets.

The instruction information includes, for example, information of a character string “Please extract a plurality of investigation targets from the given investigation target content and generate a plurality of search queries for respectively searching for information corresponding to the corresponding investigation targets among these plurality of investigation targets. Please output the investigation targets and the search queries by associating the investigation targets and the search queries with each other for each investigation target.”, but is not limited to such an example.

The generation unit 32 uses the generative AI via the API provided by the external information processing apparatus, but is not limited to such an example. For example, the information processing apparatus 1 may have a configuration in which the generative AI is provided inside and the internal generative AI is used.

In addition, the instruction information may include investigation target extraction condition information, search query generation condition information, output format information, and example information. The investigation target extraction condition information is information indicating conditions when the investigation target is extracted. The search query generation condition information is information indicating conditions when the search query is generated. The output format information is, for example, information on an output format in a JSON format. The example information is information indicating input/output examples, and includes, for example, an example of the investigation target content, examples of a plurality of investigation targets and a plurality of search queries, and the like.

Here, the extraction of the plurality of investigation targets and the generation of a search query for each investigation target by the generation unit 32 will be described with an example. FIG. 4 is a diagram illustrating an example of the investigation target content acquired by the acquisition unit 31 of the information processing apparatus 1 according to the embodiment.

As illustrated in FIG. 4, the investigation target content is content represented by a character string and includes four sentences. The first sentence is “‘Friends XXYYZZ’ is a Japanese music group,” and the second sentence is “They are known for their unique musical style that blends pop and electro sounds.”. In addition, the third sentence is “The group name has the theme of ‘Friends’, and the music contains many messages about friendship and bonds.”, and the fourth sentence is “The live performance is very energetic, and the production that values a sense of unity with the audience is a feature.”.

In this case, for example, the generation unit 32 extracts four investigation targets corresponding to the four sentences from the investigation target content. For example, the first investigation target is “‘Friends XXYYZZ’ is a Japanese music group.”, and the second investigation target is “They are known for their unique music style that blends pop and electro sounds.”.

In addition, the third investigation target is “The group name has the theme of ”Friends“, and the music contains many messages about friendship and bonds.”, and the fourth investigation target is “The live performance is very energetic, and the production that values a sense of unity with the audience is a feature.”. In these examples, the generation unit 32 converts the four sentences from the investigation target content into a “da/dearu style” to obtain four investigation targets, but is not limited to such an example.

The generation unit 32 generates search queries corresponding to each of the four investigation targets. For example, the generation unit 32 generates “Friends XXYYZZ Japan music group” as a search query corresponding to the first investigation target, and generates “Friends XXYYZZ pop electro sound music style” as a search query corresponding to the second investigation target.

In addition, the generation unit 32 generates “Friends XXYYZZ friendship bond message” as a search query corresponding to the third investigation target, and generates “Friends XXYYZZ live performance energetic sense of unity” as a search query corresponding to the fourth investigation target.

Note that, in the above-described example, the generation unit 32 collectively performs the extraction of the plurality of investigation targets and the generation of search queries for each investigation target, but it is also possible to separately perform the extraction of the plurality of investigation targets and the generation of search queries for each investigation target. For example, the generation unit 32 can extract the plurality of investigation targets using the generative AI, and then generate a search query for each investigation target using the generative AI. In addition, the generation unit 32 can also generate a plurality of search queries for each investigation target.

In addition, in a case in which there is an investigation target that requires reprocessing (for example, in a case in which there is an investigation target evaluated by the evaluation unit 34 as being unknown whether the investigation target is correct), the generation unit 32 generates a new search query corresponding to that investigation target. In this case, the generation unit 32 generates a search query different from the search query already generated corresponding to the investigation target evaluated by the evaluation unit 34 as being unknown whether the investigation target is correct.

For example, the generation unit 32 generates input information including an investigation target evaluated by the evaluation unit 34 as being unknown whether the investigation target is correct, a search query already generated corresponding to this investigation target, and instruction information including an instruction sentence to instruct generation of a new search query corresponding to the investigation target evaluated as being unknown whether the investigation target is correct. The generation unit 32 inputs the generated input information into the generative AI, and causes the generative AI to output a new search query corresponding to the investigation target evaluated as being unknown whether the investigation target is correct.

### [3.3.4. Search Unit 33]

The search unit 33 performs various types of searches. For example, the search unit 33 performs a search using the search query generated by the generation unit 32 for each investigation target. The search query generated by the generation unit 32 includes, for example, one or more search keywords, and the search unit 33 performs a search for one or more pieces of web content or the like using the search query generated by the generation unit 32.

For example, the search unit 33 performs a search using the search query generated by the generation unit 32 for each investigation target by transmitting the search query to one or more information providing devices 3 and causing the one or more information providing devices 3 to execute a search corresponding to the search query for each investigation target.

The one or more information providing devices 3 to which the search query is transmitted have, for example, a search engine, and perform a search corresponding to the search query by using such a search engine. The one or more information providing devices 3 provide a search result corresponding to the search query to the search unit 33. Note that the information processing apparatus 1 may have a function of a search engine, and in this case, the search unit 33 performs a search corresponding to the search query using the search engine in the information processing apparatus 1.

In a case in which a new search query is generated by the generation unit 32, the search unit 33 performs a search using the new search query by a method similar to the above-described method.

### [3.3.5. Evaluation Unit 34]

The evaluation unit 34 evaluates, based on a search result for each investigation target by the search unit 33, the correctness of the content of the investigation target content for each investigation target. The evaluation unit 34 evaluates, for example, using the generative AI, whether the content of the investigation target corresponding to the search query generated by the generation unit 32 is correct for each investigation target.

For example, the evaluation unit 34 generates, for each investigation target, input information (a prompt) including an investigation target corresponding to a search query, a search result corresponding to the search query, and instruction information including an instruction sentence to instruct evaluation of the correctness of the content of the investigation target. The evaluation unit 34 inputs the generated input information (the prompt) into the generative AI, and causes the generative AI to output an evaluation result of the correctness of the content of the investigation target for each investigation target.

The instruction information in this case includes, for example, information of the character string “Please perform an evaluation of whether the content of the given investigation target is correct, based on the given search result. Please output the evaluation result together with the reason for the evaluation. In addition, if it is not possible to evaluate whether the content of the given investigation target is correct, please output to that effect.”, but is not limited to such an example.

Note that the evaluation unit 34 can also cause the generative AI to evaluate the correctness of the contents of the plurality of investigation targets at once. For example, the evaluation unit 34 generates input information (a prompt) including a set of the investigation target and the search result for each investigation target, and including instruction information to instruct evaluation of the correctness of the content of each investigation target. The information processing apparatus 1 inputs the generated input information (prompt) into the generative AI, and causes the generative AI to output, at once, an evaluation result of the correctness of the content of each investigation target.

In a case in which a new search query is generated by the generation unit 32, the evaluation unit 34 re-evaluates, based on a search result of the new search query by the search unit 33, whether the investigation target, the correctness of which is evaluated as being unknown, is correct.

The evaluation unit 34 includes a generation processing unit 40 that generates the above-described input information (the prompt), which is information to be input into the generative AI, and an evaluation processing unit 41 that causes the generative AI to execute evaluation of the correctness of the content of the investigation target using the input information generated by the generation processing unit 40.

The generation processing unit 40 generates input information (a prompt) including an investigation target corresponding to a search query, a search result corresponding to the search query, and the above-described instruction information. The evaluation processing unit 41 inputs the input information (the prompt) generated by the generation processing unit 40 into the generative AI, and causes the generative AI to execute evaluation of the correctness of the content of the investigation target.

In addition, the generation processing unit 40 generates a search/evaluation result which is a result of the above-described processing. The search/evaluation result includes a reference URL, a reason for correctness/incorrectness evaluation, a result of the correctness/incorrectness evaluation, and the like. The reference URL is a URL of web content that is searched by the search unit 33 and serves as a basis for the correctness/incorrectness evaluation. The reason for the correctness/incorrectness evaluation is a reason for having evaluated whether the content of the investigation target is correct. The result of the correctness/incorrectness evaluation is an evaluation result of whether the content of the investigation target is correct, and includes information indicating that the truth or falsity is unknown in a case in which the evaluation unit 34 cannot evaluate whether the content of the investigation target is correct. The information indicating that the truth or falsity is unknown is information indicating that it is unknown whether the content of the investigation target is correct.

Note that the generation processing unit 40 can also further evaluate the overall correctness of the content of the investigation target content, in addition to the correctness/incorrectness evaluation for each investigation target. For example, the generation processing unit 40 can also input, into the generative AI, input information including a correctness/incorrectness evaluation for each investigation target, and instruction information including an instruction sentence to instruct an evaluation of the overall correctness of the content of the investigation target content from the correctness/incorrectness evaluation for each investigation target, and cause the generative AI to output information indicating whether the content of the investigation target content is overall correct. In this case, the search/evaluation result includes information indicating whether the content of the investigation target content is overall correct.

The evaluation processing unit 41 performs a necessity determination of reprocessing based on the search/evaluation result generated by the generation processing unit 40. For example, the evaluation processing unit 41 determines whether there is an investigation target whose result of the correctness/incorrectness evaluation includes information indicating that the truth or falsity is unknown. Then, in a case in which there is an investigation target whose result of the correctness/incorrectness evaluation includes the information indicating that the truth or falsity is unknown, the evaluation processing unit 41 determines that reprocessing is necessary for the investigation target. Conversely, in a case in which such an investigation target does not exist, the evaluation processing unit 41 determines that reprocessing is not necessary for the investigation target.

For a re-investigation target, which is an investigation target whose result of the correctness/incorrectness evaluation includes the information indicating that the truth or falsity is unknown, the generation processing unit 40 generates input information (a prompt) using the result of a re-search by the search unit 33. The evaluation processing unit 41 inputs the input information (the prompt) corresponding to the re-investigation target into the generative AI, and causes the generative AI to execute evaluation of the correctness of the content of the re-investigation target. In this case, the generation processing unit 40 generates the regenerated search/evaluation result as an investigation result in a case in which the evaluation processing unit 41 evaluates that reprocessing is not necessary for all the investigation targets, but in a case in which the result of the correctness/incorrectness evaluation is unknown in truth or falsity even after a plurality of times of re-investigation, information to that effect is included in the search/evaluation result for the investigation result, and such a search/evaluation result is treated as the investigation result.

Note that, in the above-described example, the evaluation processing unit 41 performs a necessity determination of reprocessing based on the search/evaluation result generated by the generation processing unit 40, but is not limited to such an example. For example, in an output from the generative AI, in a case in which there is an investigation target whose result of the correctness/incorrectness evaluation includes information indicating that the truth or falsity is unknown, the evaluation processing unit 41 can determine that reprocessing is necessary for the investigation target. Conversely, in a case in which such an investigation target does not exist, the evaluation processing unit 41 can determine that reprocessing is not necessary for the investigation target. In this case, the generation processing unit 40 can generate the search/evaluation result only in a case in which the evaluation processing unit 41 evaluates that reprocessing is not necessary for all the investigation targets.

### [3.3.6. Provision Unit 35]

The provision unit 35 provides various types of information to the information providing device 3, the terminal device 2, or the like. For example, the provision unit 35 transmits an investigation result including an evaluation result by the evaluation unit 34 to a device (for example, the information providing device 3 or the terminal device 2), which is a provider of the investigation target content, thereby providing the investigation result including the evaluation result by the evaluation unit 34 to the provider of the investigation target content.

The investigation result provided by the provision unit 35 includes, for example, evaluation information including an investigation target, a reference URL, a reason for a correctness/incorrectness evaluation, and a result of the correctness/incorrectness evaluation for each investigation target, and conclusion information indicating the overall correctness of the content of the investigation target content.

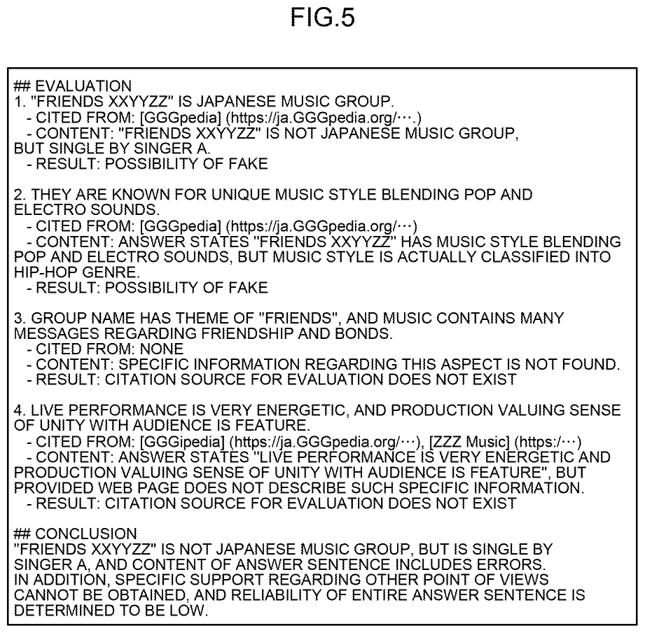

FIG. 5 is a diagram illustrating an example of the investigation result provided by the provision unit 35 of the information processing apparatus 1 according to the embodiment. In the example illustrated in FIG. 5, in the evaluation information, the four investigation targets described above are listed, and the reference URL, the reason for the correctness/incorrectness evaluation, and the result of the correctness/incorrectness evaluation are indicated for each investigation target. In the example illustrated in FIG. 5, the reference URL is indicated following a character string “Source:”, and in a case in which there is no reference URL, a character string “None” is indicated.

In addition, in the example illustrated in FIG. 5, the reason for the correctness/incorrectness evaluation is indicated following a character string “Content:”, and the result of the correctness/incorrectness evaluation is indicated following a character string “Result:”. In addition, in the example illustrated in FIG. 5, the conclusion information is indicated following “##Conclusion”.

Note that, although the investigation result illustrated in FIG. 5 is not in the JSON format, the provision unit 35 can output the investigation result in the JSON format.

In addition, the provision unit 35 can also provide, for example, the investigation result of the investigation target content in an online service. For example, in a case in which the investigation target content is summarized content obtained by summarizing comments on a news article, the provision unit 35 provides the investigation result of the summarized content, which is the investigation target content, in a news provision service that provides the news article used for the summary.

The provision unit 35 can also generate and provide a heat map based on the correctness/incorrectness evaluation for each investigation target by the evaluation processing unit 41. For example, the provision unit 35 generates a heat map in which a color corresponding to the correctness/incorrectness evaluation is applied for each investigation target in the investigation target content, and provides the investigation target content to which the generated heat map is applied. Note that the heat map is generated by applying a color corresponding to the correctness/incorrectness evaluation to each portion corresponding to each investigation target in the investigation target content, but is not limited to such an example. Note that the color in the heat map is a background color or a character color, but is not limited to such an example.

The evaluation processing unit 41 can determine a reliability score indicating a degree of correctness during the correctness/incorrectness evaluation using the generative AI. In this case, the provision unit 35 can also generate a heat map in which a color corresponding to the reliability score is applied to each portion corresponding to each investigation target in the investigation target content, and provide the investigation target content to which the generated heat map is applied. Note that the color in the heat map is a background color or a character color, but is not limited to such an example.

### 4. Processing Procedure

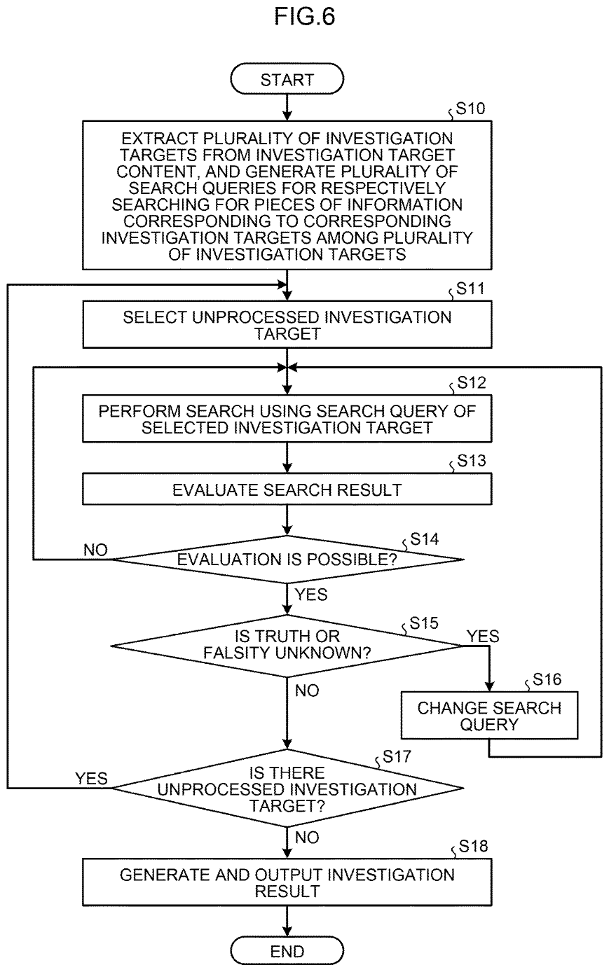

Next, a procedure of information processing by the processing unit 12 of the information processing apparatus 1 according to the embodiment will be described. FIG. 6 is a flowchart illustrating an example of information processing by the processing unit 12 of the information processing apparatus 1 according to the embodiment.

As illustrated in FIG. 6, the processing unit 12 of the information processing apparatus 1 extracts a plurality of investigation targets from the investigation target content, and generates a plurality of search queries for respectively searching for pieces of information corresponding to the corresponding investigation targets among these plurality of investigation targets (Step S10).

Subsequently, the processing unit 12 selects an unprocessed investigation target (Step S11). Then, the processing unit 12 performs a search using the search query of the investigation target selected in Step S11 (Step S12), and evaluates a search result, which is a result of such a search (Step S13).

Subsequently, the processing unit 12 determines whether evaluation has been possible in Step S13 (Step S14). For example, in Step S14, the processing unit 12 determines that evaluation is possible in a case in which whether the content of the investigation target selected in Step S11 is correct is evaluated in Step S13, or in a case in which the truth or falsity of the content of the investigation target selected in Step S11 is evaluated as being unknown in Step S13.

Upon determining that evaluation is not possible in Step S13 (Step S14: No), the processing unit 12 shifts the processing to Step S12. Upon determining that evaluation is possible in Step S13 (Step S14: Yes), the processing unit 12 determines whether the truth or falsity of the content of the investigation target selected in Step S11 is evaluated as being unknown in Step S13 (Step S15).

Upon evaluating that the truth or falsity of the content of the investigation target selected in Step S11 is unknown (Step S15: Yes), the processing unit 12 changes the search query (Step S16), and shifts the processing to Step S12. Upon evaluating that the truth or falsity of the content of the investigation target selected in Step S11 is not unknown (Step S15: No), the processing unit 12 determines whether there is an unprocessed investigation target (Step S17).

Upon determining that there is an unprocessed investigation target (Step S17: Yes), the processing unit 12 shifts the processing to Step S11, and upon determining that there is no unprocessed investigation target (Step S17: No), the processing unit 12 generates and outputs the investigation result (Step S18), and ends the processing illustrated in FIG. 6.

### 5. Modification

In the above-described example, the generation unit 32 extracts a plurality of investigation targets using the generative AI, but is not limited to such an example. The generation unit 32 can also, for example, extract each sentence included in the investigation target content as an investigation target.

In addition, the generation unit 32 has a general-purpose word list in which general-purpose words (general-purpose parts of speech) are listed, and can also extract, as an investigation target, a sentence including words other than words included in the general-purpose word list (for example, a noun, a pair of a noun and a verb, a pair of a noun and an adjective, a pair of a noun and a gerund, and the like). In addition, the generation unit 32 can also vectorize each sentence included in the investigation target content, and extract, as an investigation target, a sentence corresponding to a vector outside a specific vector range.

In addition, the generation unit 32 has a negative word list in which negative words are listed, and can also extract, as an investigation target, a sentence including the negative word included in the negative word list.

In addition, in a case in which the investigation target content is content obtained by summarizing a plurality of pieces of post information for a specific news article, the generation unit 32 can also extract a sentence as an investigation target in a case in which the sentence including words (for example, a noun, a pair of a noun and a verb, a pair of a noun and an adjective, a pair of a noun and a gerund, and the like) common to two or more pieces of post information with low evaluations among the plurality of pieces of post information for the specific news article exists in the investigation target content.

In the above-described example, the generation unit 32 generates a search query using the generative AI, but is not limited to such an example. For example, the generation unit 32 can also generate a search query including one or more words (for example, a noun, a pair of a noun and a verb, a pair of a noun and an adjective, a pair of a noun and a gerund, and the like) that are not included in the general-purpose word list among the investigation targets.

In the above-described example, the generation unit 32 generates a search query including one or more search keywords as a search query, but is not limited to such an example. For example, the generation unit 32 can generate a search query including the content of the investigation target as it is, or can vectorize the content of the investigation target and generate a search query including the vectorized investigation target.

In addition, in the above-described example, the evaluation unit 34 evaluates the correctness of the content of the investigation target content for each investigation target using the generative AI, but is not limited to such an example. For example, the evaluation unit 34 can also vectorize and compare a search result of the search query and the content of the investigation target, and evaluate that the content of the investigation target is correct in a case in which a difference between vectors of the search result of the search query and the content of the investigation target is within a threshold value, and evaluate that the content of the investigation target is not correct in a case in which the difference is not within the threshold value.

In addition, the generation unit 32 can also generate search range information, which is information indicating a search range, for each investigation target, in addition to the extraction of the plurality of investigation targets and the generation of search queries for each investigation target. The search range is, for example, a range of one or more of an online encyclopedia (for example, Wikipedia (registered trademark) or other online encyclopedias), a news site, an academic paper database, a government agency website, and the like, but is not limited to such an example. For example, the search range may be a range of one or more of a specific online encyclopedia, a specific news site, a specific academic paper database, a specific government agency website, and the like.

The search unit 33 can also perform a search using the search query generated by the generation unit 32 for each investigation target within a search range indicated by the search range information generated by the generation unit 32. The search unit 33 can use, as the search result, information within the search range indicated by the search range information generated by the generation unit 32 among the search results of a search engine, or can perform a search by including information indicating the search range in the search query.

In addition, in the above-described example, the search unit 33 searches for web content, but a search target of the search unit 33 is not limited to the web content, and may be, for example, information included in a database inside the information processing apparatus 1.

In addition, in a case in which the investigation result for each investigation target content is stored in the storage unit 11, it is assumed that investigation target content identical to the investigation target content, the investigation result of which is stored in the storage unit 11, is received by the reception unit 30. In this case, the processing unit 12 can provide, to a provider or the like of the investigation target content, the investigation result of the investigation target content identical to the investigation target content newly received by the reception unit 30, which is the investigation result stored in the storage unit 11, through the processing of the provision unit 35 without performing the processing of the search unit 33 or the evaluation unit 34. Note that the processing unit 12 can also perform this processing only in a case in which the identical investigation target content is received from the identical provider.

In addition, the investigation target content may be content including a plurality of pieces of post information posted on the identical news article and not summarized. In this case, the processing unit 12 performs a search for a plurality of investigation targets included in the investigation target content, and evaluates, based on the search result, the overall correctness of the post information for each piece of post information. The processing unit 12 can calculate, based on the evaluation result for each piece of post information, a ratio of the correctness of the post information (for example, correct post information is 60% or the like), and include the calculated ratio in the investigation result.

### 6. Hardware Configuration

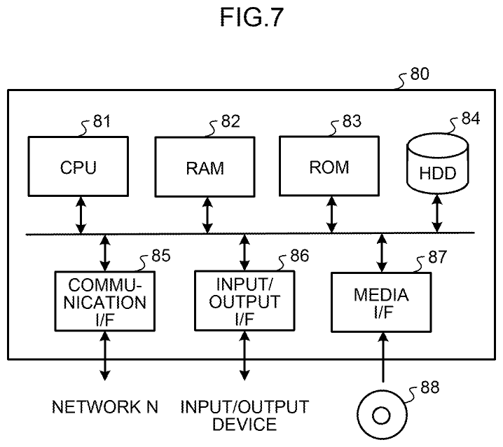

The information processing apparatus 1 according to the above-described embodiment is implemented, for example, by a computer 80 having a configuration as illustrated in FIG. 7. FIG. 7 is a hardware configuration diagram illustrating an example of the computer 80 that implements the functions of the information processing apparatus 1 according to the embodiment. The computer 80 includes a CPU 81, a RAM 82, a Read Only Memory (ROM) 83, a Hard Disk Drive (HDD) 84, a communication interface (I/F) 85, an input/output interface (I/F) 86, and a media interface (I/F) 87.

The CPU 81 operates based on a program stored in the ROM 83 or the HDD 84, and controls each unit. The ROM 83 stores a boot program executed by the CPU 81 when the computer 80 is started, a program depending on the hardware of the computer 80, and the like.

The HDD 84 stores a program executed by the CPU 81, data used by the program, and the like. The communication interface 85 receives data from another device via the network N (refer to FIG. 2) and sends the data to the CPU 81, and transmits data generated by the CPU 81 to another device via the network N.

The CPU 81 controls an output device such as a display and a printer, and an input device such as a keyboard or a mouse via the input/output interface 86. The CPU 81 acquires data from the input device via the input/output interface 86. In addition, the CPU 81 outputs the generated data to the output device via the input/output interface 86.

The media interface 87 reads a program or data stored in a recording medium 88 and provides the program or the data to the CPU 81 via the RAM 82. The CPU 81 loads the program from the recording medium 88 onto the RAM 82 via the media interface 87, and executes the loaded program. The recording medium 88 is, for example, an optical recording medium such as a Digital Versatile Disc (DVD) or a Phase change rewritable Disk (PD), a magneto-optical recording medium such as a Magneto-Optical disk (MO), a tape medium, a magnetic recording medium, or a semiconductor memory.

For example, when the computer 80 functions as the information processing apparatus 1 according to the embodiment, the CPU 81 of the computer 80 implements the function of the processing unit 12 by executing a program loaded on the RAM 82. In addition, the data in the storage unit 11 is stored in the HDD 84. The CPU 81 of the computer 80 reads and executes these programs from the recording medium 88, but as another example, the CPU 81 may acquire these programs from another device via the network N.

### 7. Others

In addition, among the processes described in the above embodiment, all or a part of the processes described as being automatically performed can be manually performed, or all or a part of the processes described as being manually performed can be automatically performed by a known method. In addition, the processing procedure, specific name, and information including various types of data and parameters illustrated in the document and the drawings can be arbitrarily changed unless otherwise specified. For example, the various types of information illustrated in each drawing are not limited to the illustrated information.

In addition, each component of each device illustrated in the drawings is functionally conceptual, and is not necessarily physically configured as illustrated in the drawings. That is, a specific form of distribution and integration of each device is not limited to the illustrated form, and all or a part thereof can be functionally or physically distributed and integrated in any unit according to various loads, usage conditions, and the like.

For example, the above-described information processing apparatus 1 may be implemented by a terminal device and a server computer, may be implemented by a plurality of server computers, or may be implemented by calling an external platform or the like with an API, network computing, or the like depending on functions, so that the configuration can be flexibly changed.

In addition, the above-described embodiments and modifications can be appropriately combined within a range in which processing contents do not contradict each other.

### 8. Effects

As described above, the information processing apparatus 1 according to the embodiment includes the acquisition unit 31, the generation unit 32, the search unit 33, and the evaluation unit 34. The acquisition unit 31 acquires investigation target content, which is content to become the investigation target. The generation unit 32 extracts a plurality of investigation targets from the investigation target content acquired by the acquisition unit 31, and generates a plurality of search queries for respectively searching for pieces of information corresponding to the corresponding investigation targets among the plurality of investigation targets. The search unit 33 performs a search using the search query generated by the generation unit 32 for each investigation target. The evaluation unit 34 evaluates, based on a search result for each investigation target by the search unit 33, the correctness of the content of the investigation target content for each investigation target. Accordingly, the information processing apparatus 1 can evaluate the correctness of the content of the investigation target content.

Furthermore, the evaluation unit 34 further evaluates the overall correctness of the content of the investigation target content. Accordingly, the information processing apparatus 1 can evaluate the overall correctness of the content of the investigation target content.

In addition, the generation unit 32 extracts a plurality of investigation targets using the generative AI. Accordingly, the information processing apparatus 1 can accurately evaluate the correctness of the content of the investigation target content.

Furthermore, the evaluation unit 34 evaluates the correctness of the content of the investigation target content for each investigation target using the generative AI. Accordingly, the information processing apparatus 1 can accurately evaluate the correctness of the content of the investigation target content.

In addition, the generation unit 32 generates the search query for each investigation target using the generative AI. Accordingly, the information processing apparatus 1 can accurately evaluate the correctness of the content of the investigation target content.

Furthermore, the evaluation unit 34 includes the generation processing unit 40 that generates a prompt to instruct the generative AI to evaluate the correctness of the investigation target from the investigation target, the search result by the search unit 33, and the investigation target and the search result by the search unit 33, and the evaluation processing unit 41 that inputs the prompt generated by the generation processing unit 40 into the generative AI and causes the generative AI to execute evaluation of correctness of content of the investigation target. Accordingly, the information processing apparatus 1 can accurately evaluate the correctness of the content of the investigation target content.

In addition, the generation unit 32 generates a new search query corresponding to the investigation target evaluated by the evaluation unit 34 as being unknown whether the investigation target is correct, and the evaluation unit 34 re-evaluates, based on a search result of the new search query by the search unit 33, whether the investigation target, the correctness of which is evaluated as being unknown, is correct. Accordingly, the information processing apparatus 1 can accurately evaluate the correctness of the content of the investigation target content.

In addition, the investigation target content is content obtained by summarizing a plurality of pieces of post information. Accordingly, the information processing apparatus 1 can evaluate the correctness of the content of the content that is obtained by summarizing the plurality of pieces of post information.

In addition, the information processing apparatus 1 includes the provision unit 35 that provides an evaluation result by the evaluation unit 34. Accordingly, the information processing apparatus 1 can provide the correctness of the content of the evaluated investigation target content.

In addition, the provision unit 35 generates a heat map in which a color corresponding to the evaluation by the evaluation unit 34 is applied for each investigation target in the investigation target content, and provides the investigation target content to which the generated heat map is applied. The information processing apparatus 1 can provide the correctness of the content of the evaluated investigation target content in an easy-to-understand manner.

Although the embodiment of the present application has been described in detail with reference to the drawings, this is merely an example, and the present invention can be implemented in other forms in which various modifications and improvements are made based on the knowledge of those skilled in the art, including the aspects described in the section of disclosure of the invention.

In addition, the above-described “unit (section, module, unit)” can be read as “means”, “circuit”, or the like. For example, the acquisition unit can be read as an acquisition means or an acquisition circuit.

What is claimed is:

1. An information processing apparatus comprising:
an acquisition unit configured to acquire investigation target content serving as content to become an investigation target;
a generation unit configured to extract a plurality of investigation targets from the investigation target content acquired by the acquisition unit, the generation unit being configured to generate a plurality of search queries for respectively searching for pieces of information corresponding to corresponding investigation targets among the plurality of investigation targets;
a search unit configured to perform, for each of the investigation targets, a search using the search queries generated by the generation unit; and
an evaluation unit configured to evaluate, based on a search result for each of the investigation targets by the search unit, correctness of content of the investigation target content for each of the investigation targets.

2. The information processing apparatus according to claim 1, wherein
the evaluation unit is configured to further evaluate overall correctness of the content of the investigation target content.

3. The information processing apparatus according to claim 1, wherein
the generation unit is configured to extract, using generative AI, the plurality of investigation targets.

4. The information processing apparatus according to claim 1, wherein
the evaluation unit is configured to evaluate, using generative AI, the correctness of the content of the investigation target content for each of the investigation targets.

5. The information processing apparatus according to claim 1, wherein
the generation unit is configured to generate, using generative AI, the search queries for each of the investigation targets.

6. The information processing apparatus according to claim 1, wherein
the evaluation unit includes:
a generation processing unit configured to generate a prompt to instruct generative AI to evaluate correctness of the investigation target from the investigation target, the search result by the search unit, and the investigation target and the search result by the search unit; and
an evaluation processing unit configured to input the prompt generated by the generation processing unit into the generative AI and to cause the generative AI to execute evaluation of correctness of content of the investigation target.

7. The information processing apparatus according to claim 1, wherein
the generation unit is configured to generate a new search query corresponding to an investigation target evaluated by the evaluation unit as being unknown whether the investigation target is correct, and
wherein the evaluation unit is configured to re-evaluate, based on a search result of the new search query by the search unit, whether the investigation target, the correctness of which is evaluated as being unknown, is correct.

8. The information processing apparatus according to claim 1, wherein
the investigation target content is content obtained by summarizing a plurality of pieces of post information.

9. The information processing apparatus according to claim 1, comprising
a provision unit configured to provide an evaluation result by the evaluation unit.

10. The information processing apparatus according to claim 1, wherein
the provision unit is configured to generate a heat map in which a color corresponding to the evaluation by the evaluation unit is applied for each of the investigation targets in the investigation target content, and to provide the investigation target content to which the generated heat map is applied.

11. An information processing method executed by a computer, the method comprising:
acquiring investigation target content serving as content to become an investigation target;
extracting a plurality of investigation targets from the investigation target content, and generating a plurality of search queries for respectively searching for pieces of information corresponding to corresponding investigation targets among the plurality of investigation targets;
performing, for each of the investigation targets, a search using the search queries; and
evaluating, based on a search result for each of the investigation targets, correctness of content of the investigation target content for each of the investigation targets.

12. A non-transitory computer readable storage medium storing therein an information processing program for causing a computer to execute processing comprising:
acquiring investigation target content serving as content to become an investigation target;
extracting a plurality of investigation targets from the investigation target content, and generating a plurality of search queries for respectively searching for pieces of information corresponding to corresponding investigation targets among the plurality of investigation targets;
performing, for each of the investigation targets, a search using the search queries; and
evaluating, based on a search result for each of the investigation targets, correctness of content of the investigation target content for each of the investigation targets.
